(19) United States
(12) Patent Application Publication
(10) Pub. No.: US 2024/0336182 A1
(43) Pub. Date: Oct. 10, 2024

(54) PNEUMATIC CUSHION TILT AND THIGH EXTENSION

(71) Applicant: Lear Corporation, Southfield, MI (US)

(72) Inventors: Samuel BLAIR, Troy, MI (US); David ABDELLA, Royal Oak, MI (US); Joshua HALLOCK, Warren, MI (US)

(21) Appl. No.: 18/296,119

(22) Filed: Apr. 5, 2023

(51) Int. Cl. B60N 2/90

(52) U.S. Cl. CPC B60N 2/914; B60N 2/995

(57) ABSTRACT

Bladder assemblies to adjust the position of a seat assemblies are disclosed. In various embodiments, the bladder assemblies include pneumatic systems to inflate and deflate one or more of a plurality of bladders. For example, a first bladder of the bladder assembly may inflate to provide a leg extension feature to support occupants with longer legs. A second bladder of the bladder assembly may inflate to provide a tilting effect to the seat assembly.

### TECHNICAL FIELD

A fluid system such as a pneumatic system to adjust a seat arrangement such as for a vehicle is disclosed. More specifically the fluid system (e.g., pneumatic system) may be used to provide a tilting effect to the seat arrangement or extend the seat.

### BRIEF DESCRIPTION OF THE DRAWINGS

FIG. 1 is a perspective view of a seat frame with a bladder assembly disposed thereon.

FIG. 2 is side view of seat assembly with the bladder assembly in a normal position.

FIG. 3 is a side view of the seat assembly with the bladder assembly in a tilted position.

FIG. 4 is a side view of the seat assembly with the bladder assembly in a leg extension position.

FIG. 5 is a side view of the seat assembly with the bladder assembly in a tilted and leg extension position.

FIG. 6 is a side view of a seat assembly where the seat adjustment features are built into the seat frame.

FIG. 7 is perspective view of an embodiment of a first end of the seat bottom with a bladder assembly disposed thereon.

FIG. 8 is the bladder assembly of FIG. 7 with the bladders filled.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

Embodiments of the present disclosure are described herein. It is to be understood, however, that the disclosed embodiments are merely examples and other embodiments can take various and alternative forms. The figures are not necessarily to scale. Some features could be exaggerated or minimized to show details of particular components. Therefore, specific structural and functional details disclosed herein are not to be interpreted as limiting, but merely as a representative basis for teaching one skilled in the art to variously employ the embodiments of the present invention. As those of ordinary skill in the art will understand, various features illustrated and described with reference to any one of the figures can be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

Moreover, except where otherwise expressly indicated, all numerical quantities in this disclosure are to be understood as modified by the word “about” in describing the broader scope of this disclosure. Practice within the numerical limits stated is generally preferred. Also, unless expressly stated to the contrary: percent, “parts of,” and ratio values are by weight. The term “polymer” includes “oligomer,” “copolymer,” “terpolymer,” and the like. The description of a group or class of materials as suitable or preferred for given purpose implies the mixtures of any two or more of the members of the group or class are equally suitable or preferred. Molecular weights provided for any polymers refers to number average molecular weight. A description of constituents in chemical terms refers to the constituents at the time of addition to any combination specified in the description and does not necessarily preclude chemical interactions among the constituents of a mixture once mixed. The first definition of an acronym or other abbreviation applies to all subsequent uses herein of the same abbreviation and applies mutatis mutandis to normal grammatical variations of the initially defined abbreviation. Unless expressly stated to the contrary, measurement of a property is determined by the same technique as previously or later referenced for the same property.

This disclosure is not limited to the specific embodiments and methods described below, as specific components and/or conditions may vary. Furthermore, the terminology used herein is used only for the purpose of describing particular embodiments and is not intended to be limiting in any way.

The term “substantially” or “generally” may be used herein to describe disclosed or claimed embodiments. The term “substantially” or “generally” may modify a value or relative characteristic disclosed or claimed in the present disclosure. In such instances, “substantially” or “generally” may signify that the value or relative characteristic it modifies is within +0%, 0.1%, 0.5%, 1%, 2%, 3%, 4%, 5% or 10% of the value or relative characteristic.

It should also be appreciated that integer ranges explicitly include all intervening integers. For example, the integer range 1-10 explicitly includes 1, 2, 3, 4, 5, 6, 7, 8, 9, and 10. Similarly, the range 1 to 100 includes 1, 2, 3, 4 . . . 97, 98, 99, 100. Similarly, when any range is called for, intervening numbers that are increments of the difference between the upper limit and the lower limit divided by 10 can be taken as alternative upper or lower limits. For example, if the range is 1.1. to 2.1 the following numbers 1.2, 1.3, 1.4, 1.5, 1.6, 1.7. 1.8, 1.9, and 2.0 can be selected as lower or upper limits.

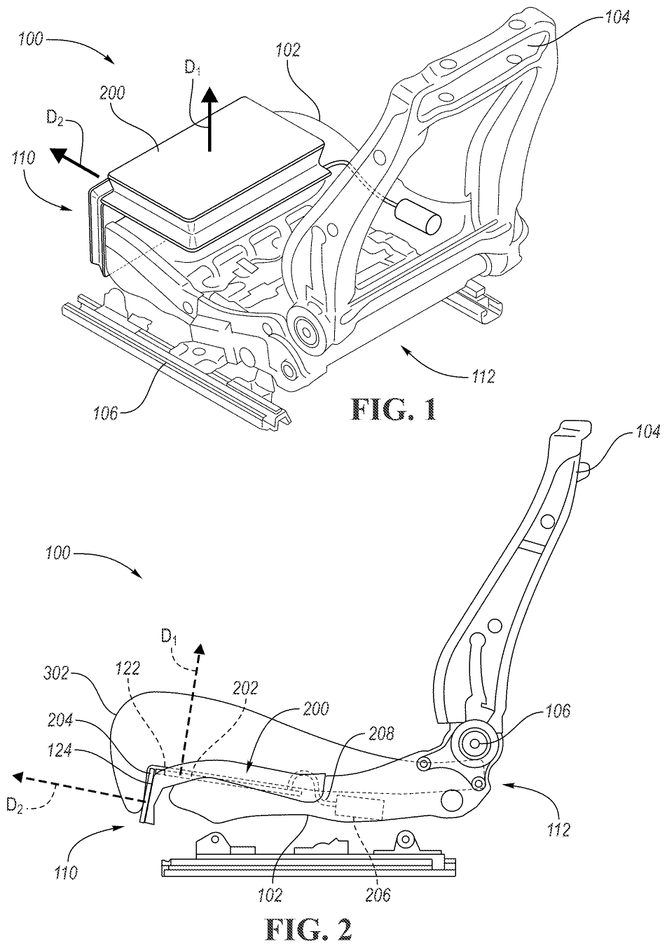

Referring to FIG. 1, a seat assembly 100 such as for a vehicle (e.g., motorcycle, automobile, locomotive, watercraft, or aircraft) is disclosed. In a variation, the seat assembly 100 includes a seat bottom 102 and a seat back 104. In one or more embodiments, the seat assembly 100 includes a frame 106, a cushion assembly, and a trim cover (not shown). In a variation, the frame 106 is made of a strong rigid material sufficient to support (e.g., hold up) the subassemblies of the seat assembly 100 (such as the cushion assembly) and a seated occupant, e.g., above a floor such as the floorboard of a vehicle. In various embodiments, the frame 106 is made of metal (e.g., aluminum and/or steel), plastic, and/or wood. In a refinement, the frame 106 is adapted to be mounted to a vehicle. The cushion assembly includes one or more cushions 302 such as but not limited to foam cushions (e.g., polyurethane foam) or cushions made of a plurality of entangled/intertwined polymeric strands. In a refinement, the seat bottom 102 includes a first end 110 and second end 112 opposite the first end 110. In various embodiments, the seat back 104 cooperates with the seat bottom 102 at the first and/or second end 110/112. The seat bottom 102 or seat back 104 includes a bladder assembly 200 to adjust the position of a seated occupant. In a refinement the bladder assembly 200 is disposed at the first or second end opposite the seat back 104.

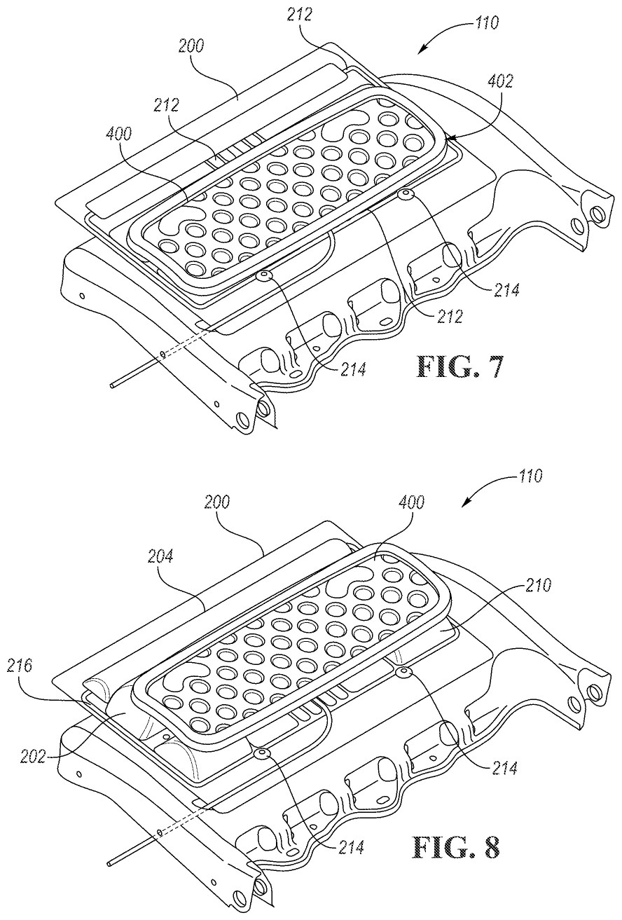

In one or more embodiment, the bladder assembly 200 includes a plurality of bladders such as a first bladder 202, a second bladder 204, a pump 206 (e.g., an air compressor in a pneumatic system), and one or more fluid passages 208 such as air hoses to transport a fluid into and/or out of the plurality of bladders. In a refinement, the bladder assembly 200 includes a valve assembly having one or more valves to control filling of various bladders in the bladder assembly 200. In a variation the valve assembly allows a first bladder of the bladder assembly 200 to be filled such as by opening a first valve while a second bladder is not filled or remains deflated because a second valve is closed. In various embodiments, the bladder assembly 200 cooperates with the frame 106. For example, the bladder assembly 200 may be fastened to the frame 106 by one or more fasteners 214 as shown in FIGS. 7-8.

In a refinement, the bladder assembly 200 is disposed proximate the cushion assembly. For example, the bladder assembly 200 is at least partially disposed between the frame 106 and a cushion of the cushion assembly. In yet another embodiment, the bladder assembly 200 is disposed on the cushion opposite the frame 106. In a refinement, when the bladder assembly 200 is filled, the bladder assembly 200 raises the first or second end 110/112 in a first direction D₁ such as by raising/lifting the first or second end of the cushion 302 upward away from the frame 106 and/or extends from the first or second end 110/112 in a second direction D₂ away from the frame 106. In a variation, the second bladder 204 extends such that it appears the cushion 302 is extended or alternatively, extends such that it stretches the cushion 302 to extend it, which provides support to longer legs (e.g., a leg extension feature). In one or more embodiments, the cushion 302 wraps around the bladder assembly and the second bladder 204 such that when the second bladder 204 expands, it pushes and stretches the cushion 302. For example, the first bladder 202 is arranged along a first surface 122 of the frame 106 and the second bladder 204 is arranged along a second surface 124 of the frame 106 that is different than the first surface.

For example, filling/inflating the first bladder 202 raises a seated occupant's knees to provide a tilting effect and filling/inflating the second bladder 204 extends to provide support more proximate the knees of a long-legged occupant. In a refinement, the first and second directions D₁ and D₂ are generally orthogonal (i.e., within 25% of 90 degrees, or more preferably within 15% of 90 degrees, or even more preferably within 10% of 90 degrees, or still more preferably within 5% of 90 degrees).

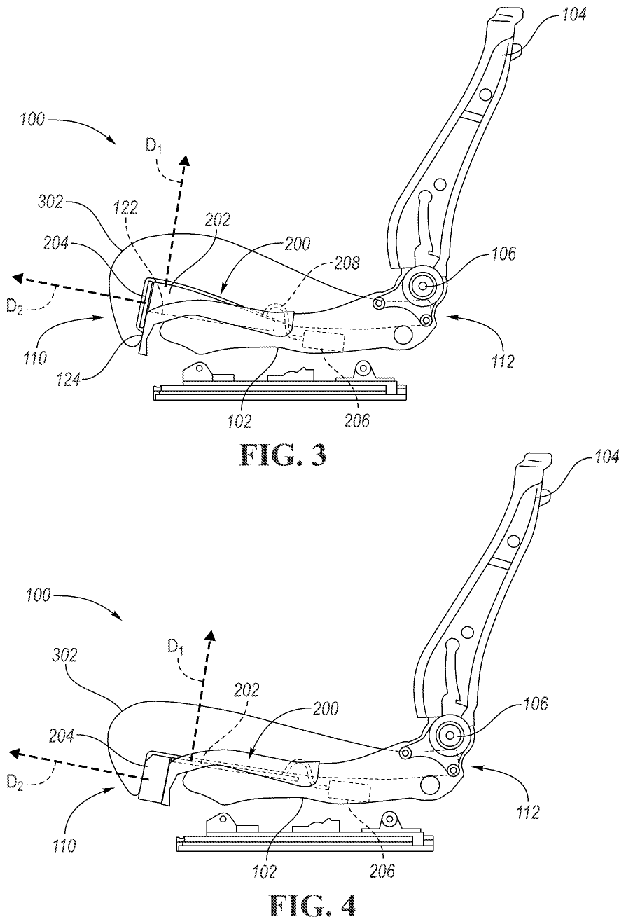

In a variation, the plurality of bladders (e.g., the first bladder 202 and the second bladder 204) are inflatable individually or simultaneously. In a first position, the bladders are deflated to provide a first normal position, as shown in FIG. 2. In a second position, the first bladder 202 is filled/inflated to provide merely a tilting effect, as shown in FIG. 3. In a third position, the second bladder 204 may be filled/inflated to provide a leg extension position, as shown in FIG. 4. In a fourth position, the first and second bladders 202 and 204 are filled/inflated to provide a tilting effect with a leg extension position, as shown in FIG. 5.

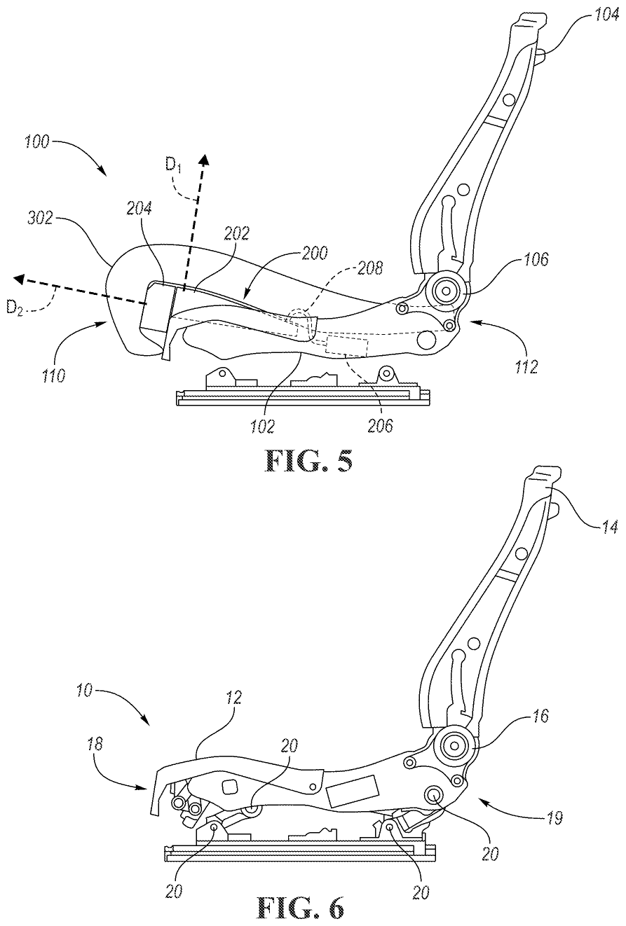

Conventional assembly 10 may offer similar features such as a tilting effect and/or leg extension feature however, it involves an extensive mechanical mechanism such as those depicted in FIG. 6. These mechanical mechanisms often make up a portion of the frame 16 and introduce joints or potential failure points 20. Accordingly, using the bladder system 200 described herein reduces the number of components, the number of failure points, and is less expensive. Further, in the automotive industry, for example, reducing the failure points reduces the amount of testing required to ensure crash or impact integrity.

The bladder assembly 200 is not particularly limited in its shape and/or size (e.g., the number of bladders). Different arrangements may provide unique benefits such as matching the traditional or expected timing associated with conventional more mechanical mechanisms. For example, in various embodiments, the bladder assembly 200 includes a plurality of bladders (e.g., at least two bladders, or more preferably five bladders as shown in FIG. 8). In a refinement, a support plate 400 is used to distribute the pressure of the bladders more evenly. For example, one or more bladders moves the support plate 400 (e.g., by lifting and/or lowering the support plate 400). The support plate 400 also allows for smaller bladders which are filled/inflated faster than larger bladders, which for example, span across the first end 110.

In various embodiments, a group of bladders (e.g., four bladders) is disposed along the periphery of the plate 400 such that when inflated the plate 400 moves in the first direction D₁. For example, each bladder (e.g., 202, 204) is disposed at a respective corner 402 of the support plate 400. In various embodiments, the bladders may be sized to fill/inflate in no more than 45 seconds, or more preferably in no more than 30 seconds, or even more preferably in no more than 15 seconds.

In various embodiments, the bladder assembly 200 includes a plurality of sheets cooperating to form the bladders. For example, the bladder assembly 200 includes a first sheet cooperating with (e.g., welded to) a second sheet to form five bladders (i.e., four bladders to provide the tilting effect and one generally cylindrical bladder to provide the leg extension feature). In various embodiment the bladder or bladders providing the leg extension feature may be disposed along an edge or end of the sheets.

In a refinement, additional welding 212 between the first and second sheets is used to provide stability and support to the bladder assembly 200 such that the bladder assembly 200 maintains the desired shape while inflated and deflated. For example, round, circular, and/or oval-shaped welds/bonds provides additional elasticity such that the bladder assembly returns to its generally flat position when deflated. In one or more embodiments, the bonds may extend a length that is greater than the length of the bladders 202, 204. In various embodiments, the sheets provide fluid passages 216 to and from the bladders. In one or more embodiments, the bladder assembly 200 wraps around the first end such that it is cooperates with a first side of the frame and a second adjacent side of the frame to provide bladders on the first and second sides that move in the first and second directions D₁ and D₂. FIGS. 7 and 8 do not depict the second side 124, as shown in FIGS. 2-5, although it should be clear that the bladder assembly 200 would be arranged such that it would wrap around the end of the frame and would cooperate with the second side 124 as well as to the first side 122 such as by fasteners 214.

In one or more embodiments, a controller (e.g., a non-transitory computer readable medium having computer executable instructions stored such that when executed by a processor the assembly performs certain programmed functions) programmed to fill/inflate a first bladder and/or a second bladder. In a variation, the controller is programmed to empty/deflate the first bladder and/or the second bladder individually or simultaneously. For example, a user control panel allows a user to select raising or lowering the seat which inflates the first bladder such that a seated occupant's knees are raised. The user control panel also includes a control to extend the cushion such that it supports longer legs.

In one or more embodiments, the processor includes one or more devices selected from high-performance computing systems including high-performance cores, microprocessors, micro-controllers, digital signal processors, microcomputers, central processing units, field programmable gate arrays, programmable logic devices, state machines, logic circuits, analog circuits, digital circuits, or any other device that manipulate signals (analog or digital) based on computer-executable instructions residing in the non-transitory computer readable medium (i.e., memory). In variations, the memory includes a single memory device or a number of memory devices including, but not limited to, random access memory (RAM), volatile memory, non-volatile memory, static random access memory (SRAM), dynamic random access memory (DRAM), flash memory, cache memory, or any other device capable of storing information. In a refinement, the non-volatile memory/storage includes one or more persistent data storage devices such as a hard drive, optical drive, tape drive, non-volatile solid state device, cloud storage or any other device capable of persistently storing information.

In one or more embodiment, the executable code/instructions may reside in a software module. In a refinement, the software module includes operating systems and applications. In various embodiments, the software module is compiled or interpreted from a computer program created using a variety of programming languages and/or technologies, including, without limitation, and either alone or in combination, Java, C, C++, C#, Objective C. Fortran, Pascal, Java Script, Python, Perl, and PL/SQL. Non-volatile storage may also include data supporting the functions, features, calculations, and processes.

In some embodiments, the systems described above include computer readable storage media, which is inherently non-transitory, and in various refinements includes volatile or non-volatile, and removable and non-removeable tangible media implemented in any method or technology for storage of information, such as computer-readable instructions, data structures, program modules, or other data. In a variation, computer readable storage media further includes RAM, ROM, erasable programmable read-only memory (EPROM), electrically erasable programmable read-only memory (EEPROM), flash memory or other solid state memory technology, portable compact disc read-only memory (CD-ROM), or other optical storage, magnetic cassettes, magnetic tape, magnetic disk storage or other magnetic storage devices, or any other medium that can be used to store the desired information and which can be read by a computer. In various embodiments, the computer readable program instructions may be downloaded to a computer, another type of programmable data processing apparatus, or another device form of a computer readable storage medium or to an external computer or external storage device via a network.

In one or more embodiments, the computer readable program instructions stored in a computer readable medium may be used to direct a computer, other types of programmable data processing apparatus, or other devices to function in a particular manner, such that the instructions stored in the computer readable medium produce an article of manufacture including instructions that implement functions, acts, and/or operations described herein. The functions, acts, and/or operations described herein may be re-ordered, processed serially, and/or processed concurrently.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

According to a first aspect of the seat assembly described herein, the seat assembly such as for a vehicle includes a seat bottom defining a first end and a second end opposite the first end. The seat bottom includes a frame, a cushion supported by the frame, and a bladder assembly. The frame may be adapted to be mounted to the vehicle. The bladder assembly is disposed proximate the cushion such as between or on the cushion. The bladder assembly may include a plurality of bladders, a pump and/or an air hose. The bladder assembly is arranged along the first end such that when filled/inflated the bladder assembly raises the first end in a first direction (e.g., upward) and/or extends the first end in a second direction (e.g., extends out to provide extension for an occupant's legs.

According to a second aspect, the bladder assembly of the first aspect or any of the following aspects is raised in the first direction such that it is arranged to lift the knees of a seated occupant providing a tilting effect.

According to a third aspect, the bladder assembly of any of the prior or subsequent aspects where the bladder assembly extends in the second direction to extend the seat cushion to support the legs of an occupant.

According to a fourth aspect, the second end of any of the prior or subsequent aspects cooperates with a seat back.

According to a fifth aspect, the seat assembly of any of the prior or subsequent aspects includes at least a first bladder and a second bladder.

According to a sixth aspect, the first and second directions of any of the prior or subsequent aspects is generally orthogonal.

According to a seventh aspect, the bladder assembly of any of the prior or subsequent aspects is in communication with a pneumatic system including a compressor.

According to an eighth aspect, the first and second bladders of any of the prior or subsequent aspects are inflatable individually or simultaneously.

According to a nineth aspect, the seat assembly described herein includes a cushion, a frame supporting the seat cushion; and a plurality of bladders disposed between the cushion and the frame at a first end. The bladder assembly includes a first bladder and a second bladder such that when the first bladder is filled/inflated the cushion moves in a first upward direction away from the frame and the second bladder is arranged such that when filled/inflated the second bladder supports an additional portion of an occupant.

According to a tenth aspect, each of the bladders of any of the prior or subsequent aspects is inflatable individually or simultaneously with the other bladders of the plurality of bladders.

According to an eleventh aspect, the additional portion of any of the prior or subsequent aspects is a leg portion.

According to a twelfth aspect, the cushion of any of the prior or subsequent aspects wraps around the second bladder.

According to a thirteenth aspect, the cushion of any of the prior or subsequent aspects is extended when the second bladder inflates.

According to a fourteenth aspect, a bladder assembly as described herein includes a first bladder sized to be arranged along a first surface of a frame, and a second bladder sized to be arranged along a second surface of the frame that is different than the first surface. The first and second surfaces extended along different direction such that the bladders expend in different directions when filled with a fluid.

According to a fifteenth aspect, the bladder assembly of any of the prior or subsequent aspects is arranged on a frame defining a first side and a second side adjacent the first side such that the first bladder is disposed on the first side and the second bladder is disposed on the second side.

According to a sixteenth aspect, the bladder assembly of any of the prior or subsequent aspects is disposed on a seat assembly having a seat bottom and a seat back, the first bladder extending such that the length of the seat bottom extends, and the second bladder extends such that an end of the seat bottom opposite the seat back is raised.

According to a seventeenth aspect, the bladder assembly of any of the prior or subsequent aspects is disposed between a frame and the cushion assembly such that the frame supports the bladder assembly and the cushion assembly.

According to an eighteenth aspect, the first and second bladders of any of the prior or subsequent aspects provides a normal position, a leg extension position, a tilted seat position, a leg extension and tilted seat position.

According to a nineteenth aspect, the normal position of any of the prior or subsequent aspects includes the first and second bladders being deflated.

According to a twentieth aspect, the leg extension position of any of the prior or subsequent aspects includes the first bladder being inflated and the second bladder being deflated.

According to a twenty-first aspect, the tilted seat position of any of the prior or subsequent aspects includes the first bladder being deflated and the second bladder being inflated.

According to a twenty-second aspect, the leg extension and tilted seat position of any of the prior or subsequent aspects includes the first and second bladders both being inflated.

What is claimed is:

1. A seat assembly comprising:
a seat bottom defining a first end and a second end opposite the first end, the seat bottom comprising
a frame; and
a cushion supported by the frame;
a bladder assembly disposed proximate the cushion, the bladder assembly arranged along the first end such that when filled the bladder assembly raises the first end in a first direction and/or extends the first end in a second direction.

2. The seat assembly of claim 1, wherein the bladder assembly is raised in the first direction such that it lifts knees of a seated occupant or in the second direction to extend the cushion to support legs of the seated occupant.

3. The seat assembly of claim 2, wherein the bladder assembly raises in the first direction such that it lifts knees of the seated occupant and extends in the second direction to extend the seat cushion to support legs of the seated occupant.

4. The seat assembly of claim 3, wherein the second end cooperates with a seat back.

5. The seat assembly of claim 1, wherein the seat assembly includes at least a first bladder and a second bladder.

6. The seat assembly of claim 5, wherein the first bladder moves a support plate in the first direction.

7. The seat assembly of claim 1, wherein the first and second directions are generally orthogonal.

8. The seat assembly of claim 1, wherein first and second bladders are inflatable individually or simultaneously.

9. A seat assembly comprising:
a seat cushion;
a frame supporting the seat cushion; and
a plurality of bladders disposed between the seat cushion and the frame at a first end, the plurality of bladders comprising a first bladder and a second bladder such that when the first bladder is filled the seat cushion moves in a first upward direction away from the frame and when the second bladder is filled it is configured to support an additional portion of an occupant.

10. The seat assembly of claim 9, wherein each of the bladders of the plurality of bladders is inflatable individually or simultaneously.

11. The seat assembly of claim 9, wherein the additional portion is a leg portion.

12. The seat assembly of claim 9, wherein the seat cushion wraps around the second bladder.

13. The seat assembly of claim 12, wherein the seat cushion is extended when the second bladder inflates.

14. A bladder assembly comprising:
a first bladder sized to be arranged along a first surface of a frame;
a second bladder sized to be arranged along a second surface of the frame that is different than the first surface, the first and second surfaces extending along different directions such that the bladders expand in different directions when filled with a fluid.

15. The bladder assembly of claim 14, wherein the bladder assembly is arranged on the frame defining a first side and a second side adjacent the first side such that the first bladder is disposed on the first side and the second bladder is disposed on the second side.

16. The bladder assembly of claim 15, wherein the bladder assembly is disposed on a seat assembly having a seat bottom and a seat back, the first bladder extending such that a length of the seat bottom extends and the second bladder extends such that a end of the seat bottom opposite the seat back is raised.

17. A seat assembly comprising the frame supporting a cushion assembly wherein the bladder assembly of claim 15 is disposed between the frame and the cushion assembly.

18. The bladder assembly of claim 15, wherein the first and second bladders provide a normal position, a leg extension position, a tilted seat position, a leg extension and tilted seat position.

19. The bladder assembly of claim 18, wherein in the normal position the first and second bladders are deflated, in the leg extension position the first bladder is inflated and the second bladder is deflated, in the tilted seat position the first bladder is deflated and the second bladder is inflated, and in the leg extension and tilted seat position the first and second bladders are both inflated.

20. A vehicle including a seat assembly having the frame supporting a cushion assembly with the bladder assembly of claim 15 disposed between the frame and cushion assembly.
